(19) United States
(12) Patent Application Publication
(10) Pub. No.: US 2025/0303996 A1
(43) Pub. Date: Oct. 2, 2025

(54) OCCUPANT PROTECTION DEVICE FOR PASSENGER SEAT

(71) Applicant: TOYODA GOSEI CO., LTD., Kiyosu-shi, (JP)

(72) Inventors: Naoki NOMOTO, Aichi (JP); Chiharu TOTANI, Aichi (JP); Daisuke NAGANO, Aichi (JP); Naoyuki FUKUI, Aichi (JP)

(21) Appl. No.: 19/087,925

(22) Filed: Mar. 24, 2025

(30) Foreign Application Priority Data
Mar. 26, 2024 (JP) 2024-049855

(51) Int. Cl. B60R 21/206; B60R 7/06; B60R 21/216

(52) U.S. Cl. CPC B60R 21/206; B60R 7/06

(57) ABSTRACT

An occupant protection device for protecting an occupant seated in a passenger seat of a vehicle, includes: an outer member which closes an opening provided, in front of a knee of the occupant, in an instrument panel of the vehicle; and an air bag device including an air bag configured to be deployed and inflated by supply of a gas to protect an upper body of the occupant, the air bag device is disposed in front of the outer member, the outer member is configured to move rearward away from the instrument panel and protect the knee of the occupant by receiving a pressure from the air bag that is deployed and inflated, and the air bag is deployed and inflated upward through a space between the instrument panel and the outer member that is in a state of being away from the instrument panel.

### CROSS-REFERENCE TO RELATED APPLICATION

This application is based on and claims priority under 35 USC 119 from Japanese Patent Application No. 2024-049855 filed on Mar. 26, 2024.

### TECHNICAL FIELD

The present invention relates to an occupant protection device for a passenger seat.

### BACKGROUND ART

Patent Literature 1 discloses an occupant protection device that protects an occupant seated in a passenger seat when a vehicle crashes. The occupant protection device includes a knee protection air bag device that protects a knee of an occupant and a passenger seat air bag device that protects an upper body of the occupant.

The knee protection air bag device is disposed inside a glove door constituting a glove box attached to an instrument panel. The glove box is located in front of the knee of the occupant seated in the passenger seat. An air bag of the knee protection air bag device is deployed and inflated in the front of the knee of the occupant by breaking an air bag cover constituting a part of the glove door when the vehicle crashes.

The passenger seat air bag device is disposed inside an upper portion of the instrument panel. An air bag of the passenger seat air bag device is deployed and inflated to front of the upper body of the occupant by breaking an air bag cover constituting a design surface of the upper portion of the instrument panel.

### PATENT LITERATURE

Patent Literature 1: JP2010-83173A

### SUMMARY OF INVENTION

In the occupant protection device described in Patent Literature 1, the occupant is protected by the knee protection air bag device and the passenger seat air bag device. However, in order to adopt the passenger seat air bag device, it is necessary to secure, inside the upper portion of the instrument panel, a space in which the passenger seat air bag device is disposed and to configure the design surface of the upper portion by the air bag cover. In this case, design for the instrument panel may be limited. Therefore, there is room for improvement in ensuring a protection performance for the occupant and improving a degree of freedom in the design of the instrument panel.

Aspects of an occupant protection device for a passenger seat for solving the above problems will be described.

[Aspect 1] An occupant protection device for a passenger seat for protecting an occupant seated in a passenger seat of a vehicle includes: when front and rear in a front-rear direction of the vehicle are referred to as front and rear, respectively, an outer member configured to close an opening provided in front of a knee of the occupant in an instrument panel of the vehicle; and an air bag device including an air bag configured to be deployed and inflated by supply of a gas to protect an upper body of the occupant. The air bag device is disposed in front of the outer member. The outer member is configured to move rearward away from the instrument panel and protect the knee of the occupant by receiving a pressure from the air bag that is deployed and inflated. The air bag is deployed and inflated upward through a space between the instrument panel and the outer member that is in a state of being away from the instrument panel.

According to the above configuration, the air bag device is disposed in front of the outer member. The outer member moves rearward away from the instrument panel by receiving the pressure from the deployed and inflated air bag. The knee of the occupant is protected by the outer member that is in the state of being away from the instrument panel.

Meanwhile, the air bag is deployed and inflated upward through the space between the instrument panel and the outer member that is in the state of being away from the instrument panel. Accordingly, the upper body of the occupant is protected by the air bag.

As described above, by activating the air bag device, the knee of the occupant is protected by the outer member, and the upper body of the occupant is protected by the air bag. Since the air bag device is disposed in front of the outer member located in front of the knee of the occupant, design for an upper portion of the instrument panel is less likely to be limited as compared with a case in which the air bag device is disposed inside the upper portion of the instrument panel. Therefore, it is possible to ensure a protection performance for the occupant and to improve a degree of freedom in design of the instrument panel.

[Aspect 2] The occupant protection device for a passenger seat according to aspect 1, in which the outer member includes a pressure receiving portion configured to receive the pressure from the air bag that is deployed and inflated, and a front surface of the pressure receiving portion is inclined with respect to an upper-lower direction to be positioned rearward toward an upper side.

According to the above configuration, the movement of the air bag is guided along the front surface of the pressure receiving portion, and thus the air bag is easily deployed and inflated upward. Accordingly, the air bag is easily deployed and inflated to the front of the upper body of the occupant. Therefore, the protection performance for the occupant is easily ensured.

[Aspect 3] The occupant protection device for a passenger seat according to aspect 1 or 2, in which the outer member includes a regulating portion protruding toward a front side from the outer member and configured to restrict the air bag from being deployed and inflated below the outer member.

According to the above configuration, the air bag is restricted from being deployed and inflated below the outer member by the regulating portion. Accordingly, the air bag is easily deployed and inflated upward through the space between the outer member and the instrument panel. Therefore, the protection performance for the occupant is easily ensured.

[Aspect 4] The occupant protection device for a passenger seat according to any one of aspects 1 to 3, in which the air bag includes a facing portion configured to be deployed and inflated rearward of the outer member that is in the state of being away from the instrument panel so that the facing portion faces a front side of the upper body of the occupant, and the outer member includes a support end portion configured to support the facing portion from the front by biting into a lower portion of the air bag.

According to the above configuration, the facing portion of the air bag is supported from the front by the support end portion, and thus the facing portion is restricted from moving to a front side. Accordingly, the upper body of the occupant can be suitably protected by the air bag.

[Aspect 5] The occupant protection device for a passenger seat according to any one of aspects 1 to 4, further including a ratchet mechanism configured to allow the outer member to move rearward away from the instrument panel and restrict the outer member from approaching the instrument panel when the air bag device is activated.

According to the above configuration, the outer member that protects the knee of the occupant in the state of being away from the instrument panel is restricted from approaching the instrument panel by the ratchet mechanism. Accordingly, when a load acts on the outer member from the rear due to contact between the outer member and the knee of the occupant, the outer member is restricted from moving to a front side. Therefore, the knee of the occupant can be suitably protected.

[Aspect 6] The occupant protection device for a passenger seat according to any one of aspects 1 to 5, further including an inner member disposed in front of the outer member, in which the air bag device is disposed in a space formed between the outer member and the inner member, and the outer member is configured to be engaged with the inner member so as not to be movable with respect to the inner member when the air bag device is not activated, and to be disengaged from the inner member and move rearward away from the instrument panel by receiving the pressure from the air bag that is deployed and inflated when the air bag device is activated.

According to the above configuration, the outer member is integrated with the inner member by being engaged with the inner member so as not to be movable with respect to the inner member when the air bag device is not activated. Accordingly, the outer member, together with the inner member, exhibits a function of closing the opening of the instrument panel.

Meanwhile, the outer member is disengaged from the inner member and moves rearward away from the instrument panel by receiving the pressure from the air bag when the air bag device is activated. Accordingly, the outer member exhibits a function of protecting the knee of the occupant.

[Aspect 7] The occupant protection device for a passenger seat according to aspect 6, further including a support member fixed to a frame of the vehicle to support the inner member from a front side.

According to the above configuration, it is possible to prevent deformation of the inner member due to a reaction force from the air bag that is deployed and inflated. Therefore, it is possible to stabilize a behavior when the air bag is deployed and inflated.

[Aspect 8] The occupant protection device for a passenger seat according to aspect 6 or 7, further including a glove box configured to open and close the opening, in which the glove box includes the outer member and the inner member, the outer member constitutes a design surface of an interior of the vehicle, the inner member has an accommodation portion capable of accommodating an accommodated object.

According to the above configuration, when the air bag is not activated, the outer member and the inner member function as a glove box having the accommodation portion. Meanwhile, when the air bag is activated, the outer member functions as a member that protects the knee of the occupant. Accordingly, the occupant protection device for a passenger seat can be applied to a vehicle including the glove box.

According to the present invention, it is possible to ensure the protection performance for the occupant and to improve the degree of freedom in the design of the instrument panel.

### BRIEF DESCRIPTION OF DRAWINGS

FIG. 1 is a perspective view showing an interior of a vehicle including an occupant protection device for a passenger seat according to an embodiment.

FIG. 2 is a cross-sectional view showing a state in which an air bag device of the occupant protection device for a passenger seat in FIG. 1 is activated.

FIG. 3 is a perspective view showing a case of the occupant protection device for a passenger seat in FIG. 1.

FIG. 4 is a perspective view showing an inner member, an outer member, and a guide member of the occupant protection device for a passenger seat in FIG. 1.

FIG. 5 is a cross-sectional view showing a state in which a glove box of the occupant protection device for a passenger seat in FIG. 1 closes an opening of an instrument panel.

FIG. 6 is a cross-sectional view showing a state in which the glove box of the occupant protection device for a passenger seat in FIG. 1 opens the opening of the instrument panel.

FIG. 7 is an enlarged cross-sectional view mainly showing the occupant protection device for a passenger seat in FIG. 2.

FIG. 8 is a cross-sectional view showing a first engagement portion of the glove box in FIG. 5.

FIG. 9 is a cross-sectional view showing a second engagement portion of the glove box in FIG. 5.

FIG. 10 is a cross-sectional view showing a ratchet mechanism of the occupant protection device for a passenger seat in FIG. 1.

FIG. 11 is a cross-sectional view showing a state in which the outer member is moved rearward from a state shown in FIG. 10 and a pin comes out from a regulating recess.

FIG. 12 is a cross-sectional view showing a state in which the outer member is moved rearward from a state shown in FIG. 11 and the pin enters the regulating recess.

FIG. 13 is a cross-sectional view showing a state in which the outer member is moved rearward from a state shown in FIG. 12 and a protruding portion is in contact with a regulating protrusion.

### DESCRIPTION OF EMBODIMENTS

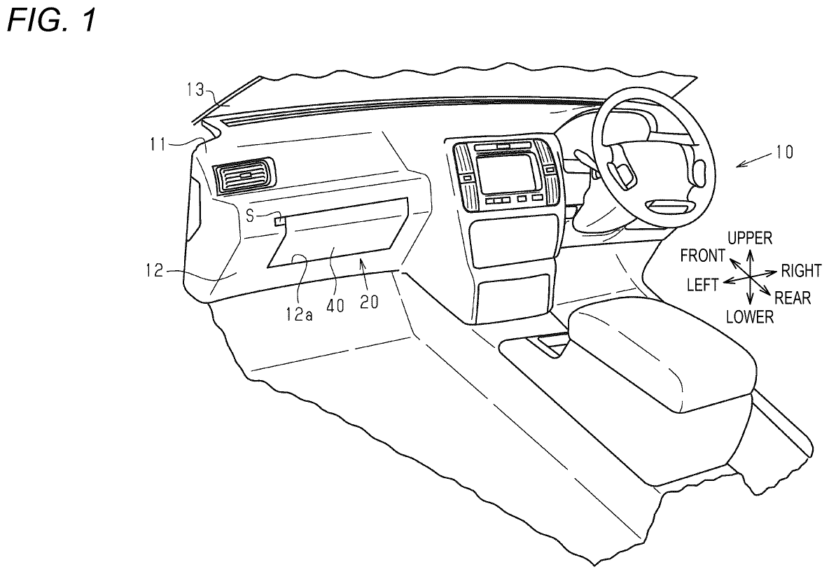

Hereinafter, an embodiment of an occupant protection device for a passenger seat will be described with reference to FIGS. 1 to 13.

In the following description, a front-rear direction, a left-right direction, and an upper-lower direction of a vehicle 10 are simply referred to as a “front-rear direction”, a “left-right direction”, and an “upper-lower direction”, respectively. Front and rear in the front-rear direction are simply referred to as “front” and “rear”, respectively. Upper and lower in the upper-lower direction are simply referred to as “upper” and “lower”, respectively. The left-right direction is the left-right direction when the vehicle 10 moves forward, and coincides with a vehicle width direction of the vehicle 10.

### (Configuration of Vehicle 10)

As shown in FIG. 1, an instrument panel 11 extending in the left-right direction is provided in a front portion of an interior of the vehicle 10. The instrument panel 11 constitutes a design surface in the interior of the vehicle 10.

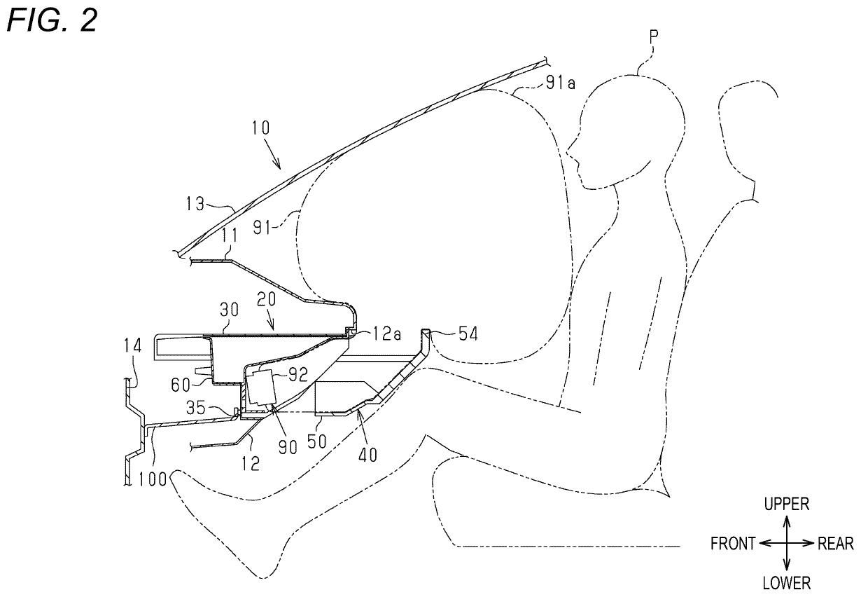

As shown in FIG. 2, a rear wall 12 of the instrument panel 11 which faces a passenger seat is inclined with respect to the front-rear direction to be positioned upward toward the rear. The rear wall 12 has an opening 12a that is provided in front of a knee of an occupant P seated in the passenger seat. A shape of the opening 12a is, for example, a substantially rectangular shape elongated in the left-right direction.

A windshield 13 is provided above the instrument panel 11. The windshield 13 extends in a manner of being inclined with respect to the upper-lower direction to be positioned rearward toward the upper side.

### (Schematic Configuration of Occupant Protection Device for Passenger Seat)

The instrument panel 11 is provided with an occupant protection device for a passenger seat (hereinafter referred to as an occupant protection device 20) which protects the occupant P seated in the passenger seat. The occupant protection device 20 includes a case 30, a glove box 40, and an air bag device 90. The case 30 and the glove box 40 are made of, for example, resin.

The case 30 is integrally or separately fixed to the instrument panel 11 to cover the opening 12a of the instrument panel 11 from the front. The case 30 has an accommodation space that is continuous with the opening 12a and accommodates the glove box 40. The glove box 40 is disposed in the front of the knee of the occupant P. The glove box 40 is configured to be able to open and close the opening 12a of the instrument panel 11 by sliding back and forth with respect to the case 30.

As shown in FIG. 1, the glove box 40 is provided with an operation switch S exposed on the design surface of the instrument panel 11. Although not shown, the glove box 40 is locked to the case 30 in a state in which the opening 12a is closed. The glove box 40 is unlocked from the case 30 by operating the operation switch S. Accordingly, the glove box 40 can slide with respect to the case 30.

As shown in FIG. 2, the glove box 40 includes an outer member 50 and an inner member 60. The outer member 50 constitutes a design surface of the glove box 40 in the interior of the vehicle. The inner member 60 is disposed in front of the outer member 50. The outer member 50 and the inner member 60 are engaged with each other.

The air bag device 90 is disposed inside the glove box 40, more specifically, in a space formed between the outer member 50 and the inner member 60.

The air bag device 90 includes an air bag 91 and an inflator 92. The air bag 91 is accommodated in a folded state in the space between the outer member 50 and the inner member 60. The inflator 92 deploys and inflates the air bag 91 by supplying inflation gas to the air bag 91. The inflator 92 is fixed to the inner member 60.

Although not shown, the air bag device 90 includes an impact sensor and a control device. The impact sensor detects an impact acting on a front portion of the vehicle 10. The control device controls an operation of the inflator 92 based on a detection signal of the impact sensor. The control device operates the inflator 92 when the impact sensor outputs the detection signal indicating that an impact of a predetermined magnitude or more acts on the vehicle 10.

When the air bag 91 is deployed and inflated, the outer member 50 moves rearward away from the instrument panel 11, more specifically, away from the inner member 60 by a pressure from the air bag 91. The air bag 91 is deployed and inflated upward through the space between the inner member 60 and the outer member 50 that is in a state of being away from the inner member 60 to protect an upper body of the occupant P. The air bag 91 includes a facing portion 91a configured to be deployed and inflated rearward of the outer member 50 that is in the state of being away from the inner member 60 so that the facing portion 91a faces the upper body of the occupant P.

In the following description, in the left-right direction, a side approaching a central portion of the occupant protection device 20 in the left-right direction is referred to as an “inner side in the left-right direction”, and a side away from the central portion is referred to as an “outer side in the left-right direction”.

### (Configuration of Case 30)

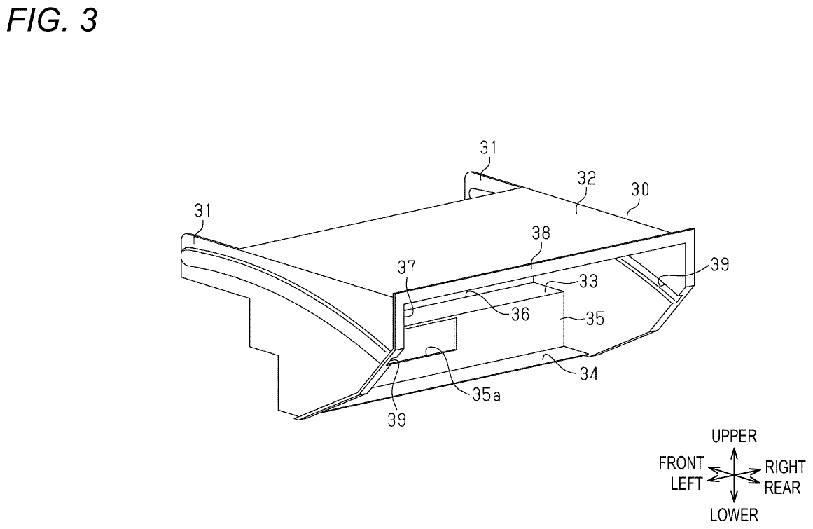

As shown in FIG. 3, the case 30 includes a pair of case side walls 31, a case top wall 32, a first case bottom wall 33, a second case bottom wall 34, and a case front wall 35.

The pair of case side walls 31 face each other in the left-right direction. Each of the case side walls 31 extends in a plane direction orthogonal to the left-right direction. A rear end surface of the case side wall 31 is inclined with respect to the front-rear direction to be positioned upward toward the rear along the rear wall 12 (see FIG. 2) of the instrument panel 11.

The case top wall 32 connects upper end portions of the pair of case side walls 31. The case top wall 32 extends in a plane direction orthogonal to the upper-lower direction.

The first case bottom wall 33 connects front portions of lower end portions of the pair of case side walls 31. The first case bottom wall 33 extends in the plane direction orthogonal to the upper-lower direction.

The second case bottom wall 34 connects rear portions of the lower end portions of the pair of case side walls 31. The second case bottom wall 34 is located below the first case bottom wall 33. The second case bottom wall 34 extends in the plane direction orthogonal to the upper-lower direction.

The case front wall 35 connects the lower end portions of the pair of case side walls 31, a rear end portion of the first case bottom wall 33, and a front end portion of the second case bottom wall 34. The case front wall 35 extends in a plane direction orthogonal to the front-rear direction. The case front wall 35 has a first through hole 35a penetrating the case front wall 35 in the front-rear direction.

The case 30 has a front opening 36 and a rear opening 37. The front opening 36 is formed by front end portions of the pair of case side walls 31, a front end portion of the case top wall 32, and a front end portion of the first case bottom wall 33. The rear opening 37 is formed by rear end portions of the pair of case side walls 31, a rear end portion of the case top wall 32, and a rear end portion of the second case bottom wall 34.

The case 30 includes a first raised portion 38 raised upward from the rear end portion of the case top wall 32. The first raised portion 38 extends in the plane direction orthogonal to the front-rear direction over the entire case top wall 32 in the left-right direction.

Each of the case side walls 31 has a guide groove 39 that guides movement of the inner member 60 described later. The guide groove 39 opens in a surface of the case side wall 31 on the inner side in the left-right direction. The guide groove 39 extends in an arc shape such that a rear end portion thereof is located below a front end portion thereof. The rear end portion of the guide groove 39 opens in a rear end surface of the case side wall 31.

### (Configuration of Inner Member 60)

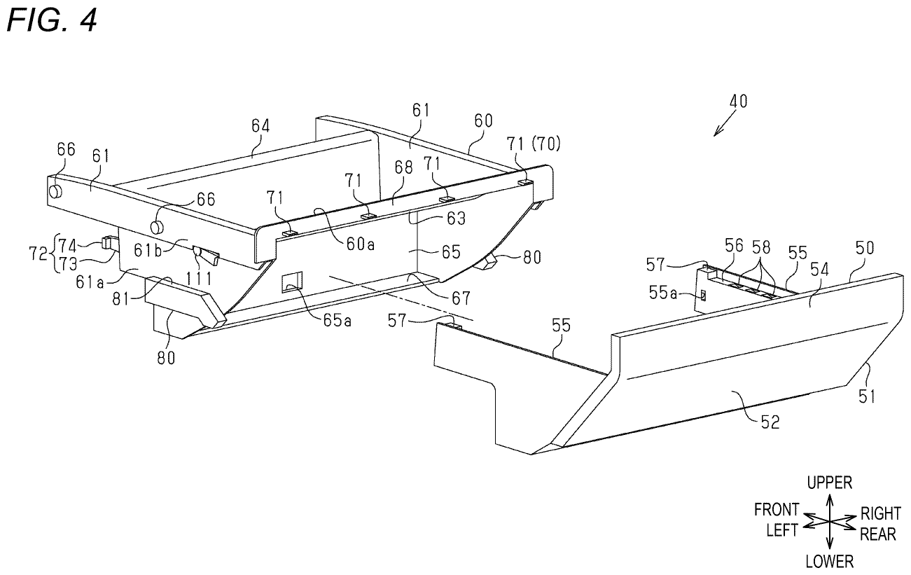

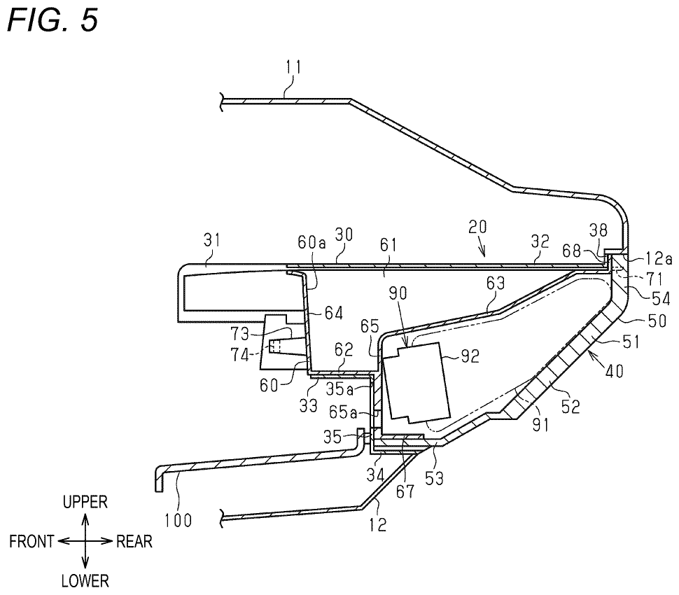

As shown in FIGS. 4 and 5, the inner member 60 includes a pair of inner side walls 61, a first inner bottom wall 62, a second inner bottom wall 63, an inner front wall 64, and an inner rear wall 65. The inner member 60 includes an accommodation portion 60a capable of accommodating an accommodated object. The accommodation portion 60a is formed by the pair of inner side walls 61, the first inner bottom wall 62, the second inner bottom wall 63, the inner front wall 64, and the inner rear wall 65. An upper opening serving as an entrance or exit of the accommodated object is formed in an upper end portion of the accommodation portion 60a.

As shown in FIG. 4, the pair of inner side walls 61 face each other in the left-right direction. Each of the inner side walls 61 extends in the plane direction orthogonal to the left-right direction. The inner side wall 61 is located on the inner side in the left-right direction of the corresponding case side wall 31.

The inner side wall 61 includes a general portion 61a and an overhang portion 61b. The general portion 61a constitutes a lower portion of the inner side wall 61. The overhang portion 61b constitutes an upper portion of the inner side wall 61. The overhang portion 61b overhangs to the outer side in the left-right direction from the general portion 61a and extends in the front-rear direction. The overhang portion 61b extends to a position further forward than the general portion 61a.

The overhang portion 61b includes a plurality of sliding shafts 66 protruding to the outer side in the left-right direction. The plurality of sliding shafts 66 are provided at intervals in the front-rear direction of the overhang portion 61b. Each of the sliding shafts 66 is configured to be slidable with respect to an inner surface of the guide groove 39 (see FIG. 3) of the case 30. The sliding shafts 66 sliding along the guide grooves 39 to guide the sliding of the glove box 40 with respect to the case 30.

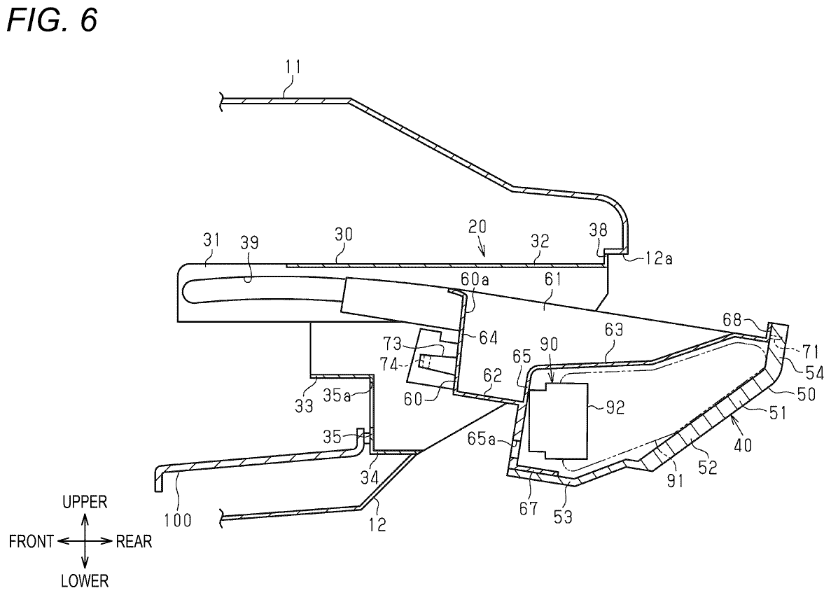

As shown in FIG. 6, when the glove box 40 slides rearward, the upper opening of the accommodation portion 60a is exposed to the interior of the vehicle 10. Accordingly, the accommodated object can be taken in and out of the accommodation portion 60a.

As shown in FIG. 5, the first inner bottom wall 62 connects front portions of lower end portions of the pair of inner side walls 61. The first inner bottom wall 62 extends in the plane direction orthogonal to the upper-lower direction. In a state in which the glove box 40 closes the opening 12a, the first inner bottom wall 62 overlaps an upper surface of the first case bottom wall 33.

The second inner bottom wall 63 connects portions of the pair of inner side walls 61 which are located rearward and upward of the portions connected by the first inner bottom wall 62. The second inner bottom wall 63 extends in a manner of being inclined with respect to the front-rear direction to be positioned upward toward the rear. A rear end portion of the second inner bottom wall 63 extends to upper end portions of the inner side walls 61.

The inner front wall 64 connects the pair of inner side walls 61 and a front end portion of the first inner bottom wall 62. The inner front wall 64 extends in a manner of being slightly inclined with respect to the front-rear direction to be positioned upward toward the front.

The inner rear wall 65 connects the pair of inner side walls 61, a rear end portion of the first inner bottom wall 62, and a front end portion of the second inner bottom wall 63. The inner rear wall 65 extends in the plane direction orthogonal to the front-rear direction. The inner rear wall 65 protrudes further downward than the first inner bottom wall 62. In the state in which the glove box 40 closes the opening 12a, a portion of the inner rear wall 65 which protrudes further downward than the first inner bottom wall 62 overlaps the rear surface of the case front wall 35.

The inner rear wall 65 has a second through hole 65a penetrating the inner rear wall 65 in the front-rear direction at the portion protruding further downward than the first inner bottom wall 62. The second through hole 65a communicates with the first through hole 35a of the case 30.

As shown in FIG. 4, the general portion 61a of the inner side wall 61 extends further rearward than the inner rear wall 65 and further downward than the second inner bottom wall 63. A rear end surface of the general portion 61a is inclined with respect to the front-rear direction to be positioned upward toward the rear along the rear wall 12 (see FIG. 2) of the instrument panel 11.

The inner member 60 includes a cover portion 67 protruding rearward from a lower end portion of the inner rear wall 65 and extending over the entire inner rear wall 65 in the left-right direction. The cover portion 67 is connected to lower end portions of the general portions 61a of the pair of inner side walls 61. The cover portion 67 extends in the plane direction orthogonal to the upper-lower direction. The cover portion 67 covers the inflator 92 from below (see FIG. 5).

The inner member 60 includes a second raised portion 68 raised upward from the rear end portion of the second inner bottom wall 63. The second raised portion 68 extends in the plane direction orthogonal to the front-rear direction over the entire second inner bottom wall 63 in the left-right direction. In the state in which the glove box 40 closes the opening 12a, the second raised portion 68 overlaps a rear surface of the first raised portion 38.

The inner member 60 includes a first engagement portion 70 and second engagement portions 72 that engage with the outer member 50. The first engagement portion 70 is provided at a front portion of the inner member 60. One second engagement portion 72 is provided on each side in the left-right direction of a rear portion of the inner member 60.

The first engagement portion 70 includes a plurality of first claw portions 71. The plurality of first claw portions 71 are provided at intervals in the left-right direction and protrude rearward from the second raised portion 68.

The second engagement portion 72 includes a base portion 73 and a second claw portion 74. The base portion 73 extends linearly to a front side from a portion of the inner front wall 64 on the outer side in the left-right direction. The second claw portion 74 protrudes to the outer side in the left-right direction from a distal end of the base portion 73.

### (Configuration of Outer Member 50)

The outer member 50 includes a lid portion 51 and a pair of outer side walls 55. A shape of the lid portion 51 corresponds to the shape of the opening 12a of the instrument panel 11. The lid portion 51 has a function of closing the opening 12a. The pair of outer side walls 55 extend to a front side from both end portions of the lid portion 51 in the left-right direction. Each of the outer side walls 55 overlaps the corresponding general portion 61a of the inner side wall 61 from the outer side in the left-right direction.

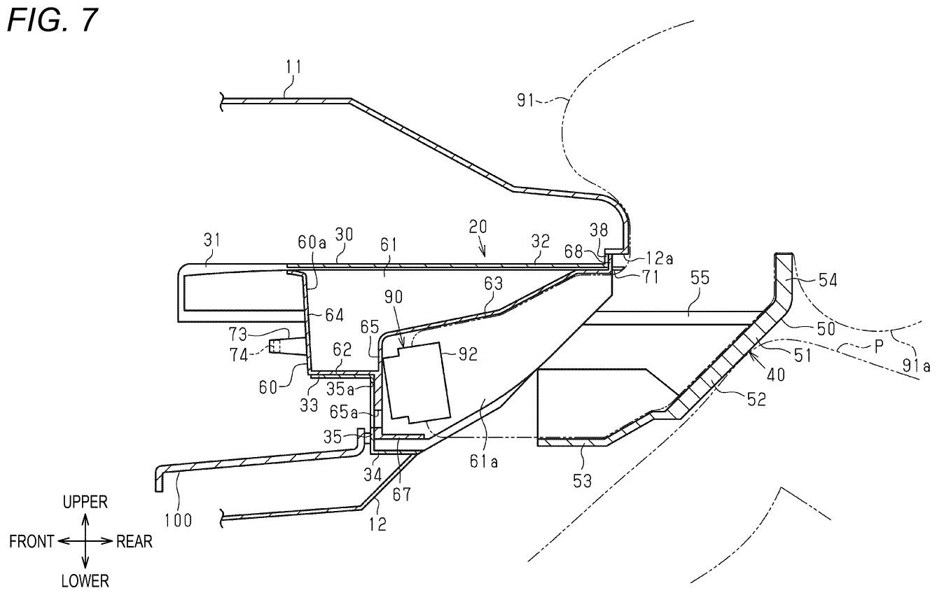

As shown in FIG. 5, the lid portion 51 includes a pressure receiving portion 52, a regulating portion 53, and a support end portion 54. The pressure receiving portion 52 is a portion that faces the rear of the air bag 91 and receives a pressure from the air bag 91. The regulating portion 53 is a portion that restricts the air bag 91 from being deployed and inflated below the outer member 50. The support end portion 54 is a portion that supports the facing portion 91a from the front by biting into a lower portion of the air bag 91 deployed and inflated rearward of the outer member 50 (see FIG. 7).

The pressure receiving portion 52 faces the inner rear wall 65 and the second inner bottom wall 63. A front surface of the pressure receiving portion 52 is inclined with respect to the upper-lower direction to be positioned rearward toward the upper side. In the present embodiment, the entire pressure receiving portion 52 is inclined with respect to the upper-lower direction to be positioned rearward toward the upper side.

The regulating portion 53 protrudes to a front side from a lower portion of the pressure receiving portion 52 and extends over the entire pressure receiving portion 52 in the left-right direction. The regulating portion 53 extends in the plane direction orthogonal to the upper-lower direction. The regulating portion 53 overlaps a lower surface of the cover portion 67 of the inner member 60. The pressure receiving portion 52 and the regulating portion 53 cover the air bag device 90 from below. In the state in which the glove box 40 closes the opening 12a, the regulating portion 53 is covered from below by the second case bottom wall 34.

The support end portion 54 protrudes upward from an upper portion of the pressure receiving portion 52 and extends over the entire pressure receiving portion 52 in the left-right direction. The support end portion 54 extends in the plane direction orthogonal to the front-rear direction. The support end portion 54 overlaps a rear surface of the second raised portion 68 of the inner member 60.

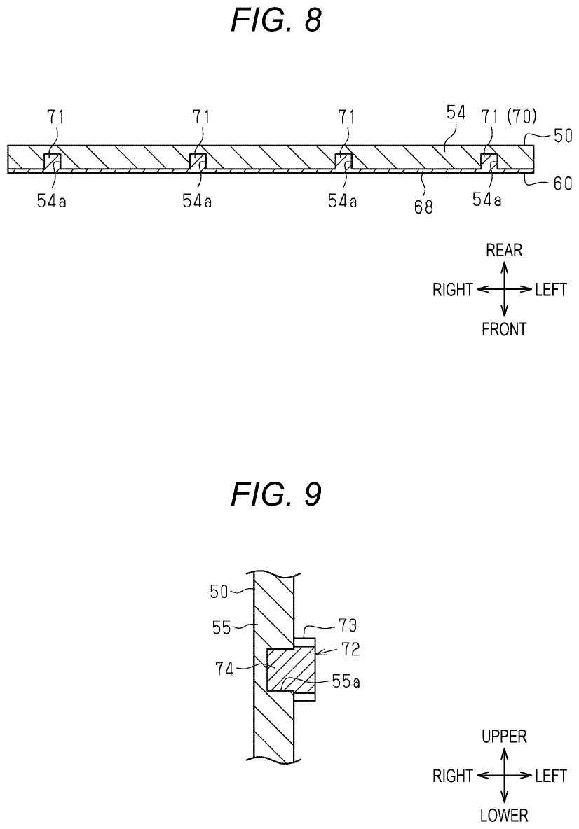

As shown in FIG. 8, the support end portion 54 has a plurality of first engagement holes 54a that engage with the plurality of first claw portions 71 of the first engagement portion 70. The first engagement holes 54a are provided at intervals in the left-right direction and open in a front surface of the support end portion 54.

As shown in FIG. 9, the outer side wall 55 has a second engagement hole 55a that engages with the second claw portion 74 of the second engagement portion 72. The second engagement hole 55a opens in a surface of the front end portion of the outer side wall 55 on the inner side in the left-right direction.

As shown in FIG. 5, the outer member 50 is engaged with the inner member 60 so as not to be movable with respect to the inner member 60 when the air bag device 90 is not activated. More specifically, as shown in FIGS. 8 and 9, the first engagement hole 54a and the second engagement hole 55a are engaged with the first claw portion 71 and the second claw portion 74, respectively, so that the outer member 50 is engaged with the inner member 60 so as not to be movable with respect to the inner member 60.

As shown in FIG. 7, the outer member 50 is disengaged from the inner member 60 and moves rearward away from the inner member 60 by receiving the pressure from the air bag 91 that is deployed and inflated when the air bag device 90 is activated. More specifically, the outer member 50 translates rearward with respect to the inner member 60. Accordingly, the outer member 50 protrudes to the front of the knee of the occupant P. The outer member 50 protects the knee of the occupant P in the state of moving rearward away from the inner member 60.

In a process of deployment and inflation of the air bag 91, the regulating portion 53 covers the air bag 91 from below. Accordingly, the air bag 91 is restricted from being deployed and inflated below the outer member 50. In the above process, the support end portion 54 bites into the air bag 91 from below. Accordingly, the facing portion 91a is restricted from moving to a front side. As shown in FIG. 2, the air bag 91 that is deployed and inflated is supported by an upper portion of the instrument panel 11, the windshield 13, and the support end portion 54.

As shown in FIG. 4, the outer side wall 55 includes a planar portion 56 and a protruding portion 57. The planar portion 56 constitutes an upper surface of the outer side wall 55 which is a flat surface orthogonal to the upper-lower direction. The planar portion 56 extends to a front side from a rear end portion of the outer side wall 55. The protruding portion 57 protrudes upward from a front end portion of the planar portion 56.

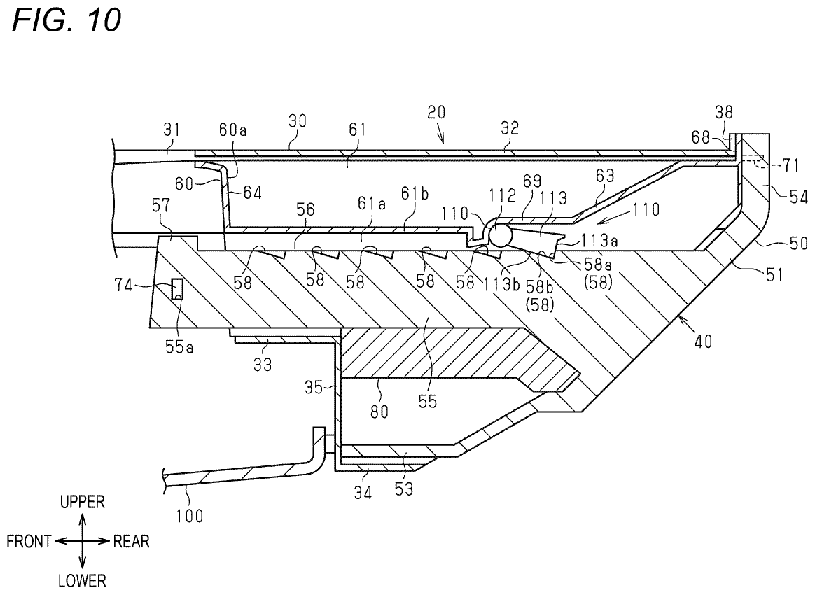

As shown in FIG. 10, a plurality of regulating recesses 58 are formed in the planar portion 56 at intervals in a moving direction of the outer member 50 with respect to the inner member 60. Each of the regulating recesses 58 opens upward. The regulating recess 58 includes a regulating surface 58a and a relief surface 58b.

The regulating surface 58a constitutes a rear end portion of the regulating recess 58. The regulating surface 58a extends in a manner of being slightly inclined with respect to the upper-lower direction to be positioned rearward toward the upper side. An upper edge of the regulating surface 58a is continuous with the planar portion 56.

The relief surface 58b constitutes a front end portion of the regulating recess 58. The relief surface 58b extends in a manner of being inclined with respect to the front-rear direction to be positioned upward toward the front. A lower edge of the relief surface 58b is continuous with a lower edge of the regulating surface 58a. An upper edge of the relief surface 58b is continuous with the planar portion 56. The regulating recess 58 has a triangular cross-sectional shape orthogonal to the left-right direction.

### (Configuration of Guide Member 80)

As shown in FIG. 4, the glove box 40 includes guide members 80 that guide the movement of the outer member 50 with respect to the inner member 60 when the air bag device 90 is activated. Each of the guide members 80 is attached to a surface of the general portion 61a of the inner side wall 61 on the outer side in the left-right direction. The guide member 80 has an elongated shape that is long in the front-rear direction. The entire guide member 80 is covered by the outer side wall 55 from the outer side in the left-right direction.

The guide member 80 includes a sliding surface 81 on which a lower surface of the outer side wall 55 slides. The sliding surface 81 faces a lower surface of the overhang portion 61b of the inner side wall 61. A part of the outer side wall 55 is sandwiched between the overhang portion 61b and the guide member 80 in the upper-lower direction. Accordingly, the outer member 50 can translate rearward with respect to the inner member 60.

### (Configuration of Support Member 100)

As illustrated in FIG. 2, the occupant protection device 20 includes a support member 100 that connects a frame 14 and the case 30 of the vehicle 10. The support member 100 is fixed to a front surface of the case front wall 35. The support member 100 is a member that receives a reaction force from the air bag 91 when the air bag device 90 is activated. The support member 100 is made of, for example, a metal. As shown in FIG. 5, in the state in which the glove box 40 closes the opening 12a, the inner rear wall 65 overlaps the rear surface of the case front wall 35. Therefore, the support member 100 supports the inner member 60 from the front via the case 30. Therefore, the support member 100 receives the reaction force from the air bag 91 via the inner member 60 and the case 30.

### (Configuration of Ratchet Mechanism 110)

As shown in FIG. 10, the occupant protection device 20 includes ratchet mechanisms 110. The ratchet mechanisms 110 are provided at both end portions of the glove box 40 in the left-right direction. The ratchet mechanisms 110 allow the outer member 50 to move rearward away from the inner member 60 and restrict the outer member 50 from approaching the inner member 60 when the air bag device 90 is activated.

Each of the ratchet mechanisms 110 includes a pin 111 attached to the inner member 60 and the plurality of regulating recesses 58 of the outer side wall 55.

The pin 111 includes a shaft portion 112 and an arm portion 113. The shaft portion 112 is attached to the inner side wall 61 to be rotatable in a forward-reverse direction about a rotation axis extending in the left-right direction. The shaft portion 112 is attached to a portion that is on the surface of the general portion 61a of the inner side wall 61 on the outer side in the left-right direction and that is adjacent to the overhang portion 61b. The arm portion 113 extends rearward from an outer peripheral portion of the shaft portion 112. In a state in which the outer member 50 is engaged with the inner member 60, the arm portion 113 enters the regulating recess 58 located at a rearmost position among the plurality of regulating recesses 58.

The arm portion 113 includes a first surface 113a and a second surface 113b. The first surface 113a is a flat surface that comes into contact with the regulating surface 58a of the regulating recess 58 in a state in which the arm portion 113 enters the regulating recess 58. The second surface 113b is a flat surface that comes into contact with the relief surface 58b of the regulating recess 58 in the state in which the arm portion 113 enters the regulating recess 58.

A rotation range of the pin 111 is restricted by a regulating protrusion 69 protruding from a surface of the inner side wall 61 on the outer side in the left-right direction. The regulating protrusion 69 covers the pin 111 from above and from the front. The regulating protrusion 69 restricts the pin 111 from rotating upward when the arm portion 113 comes into contact from below. The regulating protrusion 69 may include a portion that restricts the pin 111 from rotating downward when the arm portion 113 comes into contact from above.

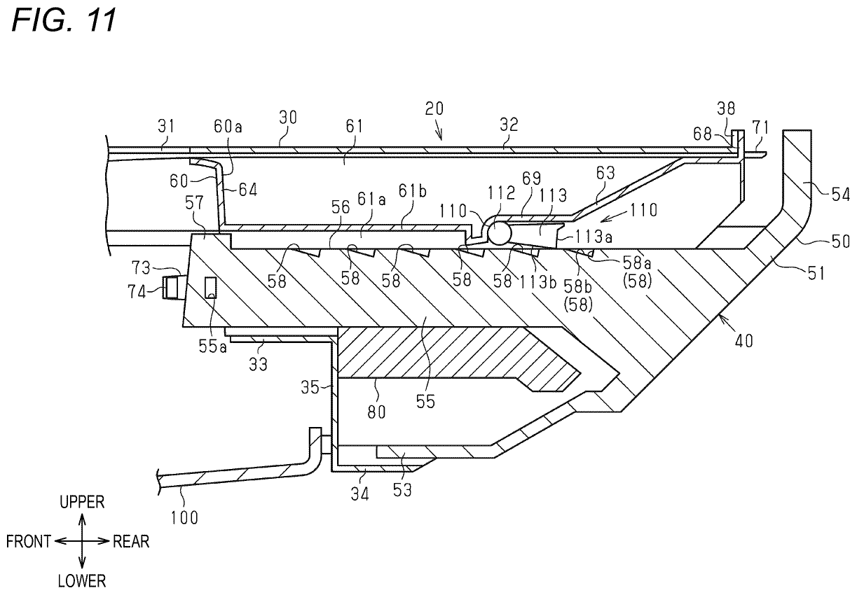

As shown in FIGS. 10 and 11, when the outer member 50 moves rearward with respect to the inner member 60 as the air bag device 90 is activated, the second surface 113b is pressed from the front by the relief surface 58b. Accordingly, an upward component force acts on the pin 111. Therefore, the pin 111 rotates upward and comes out from the regulating recess 58 to ride on the planar portion 56. Thereafter, the pin 111 slides on the planar portion 56 of the outer member 50 as the outer member 50 moves.

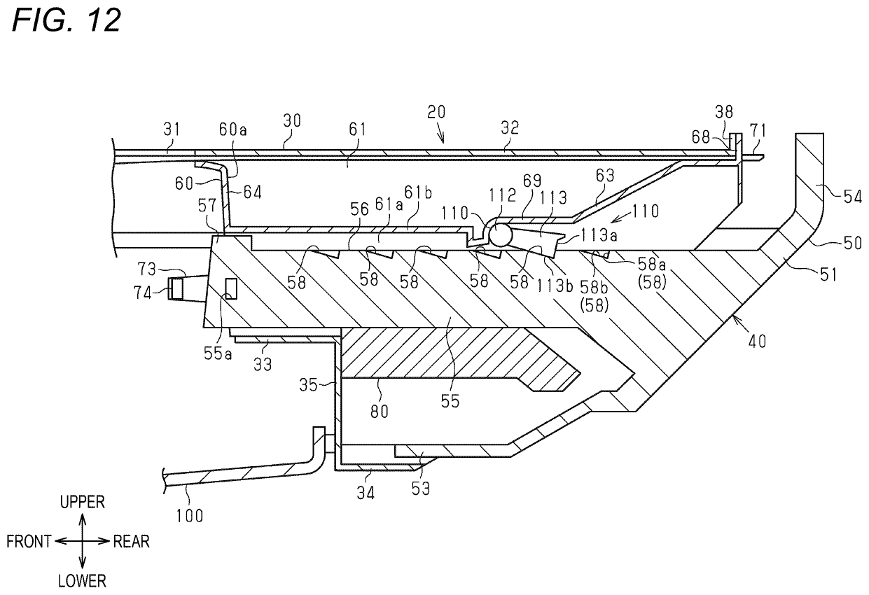

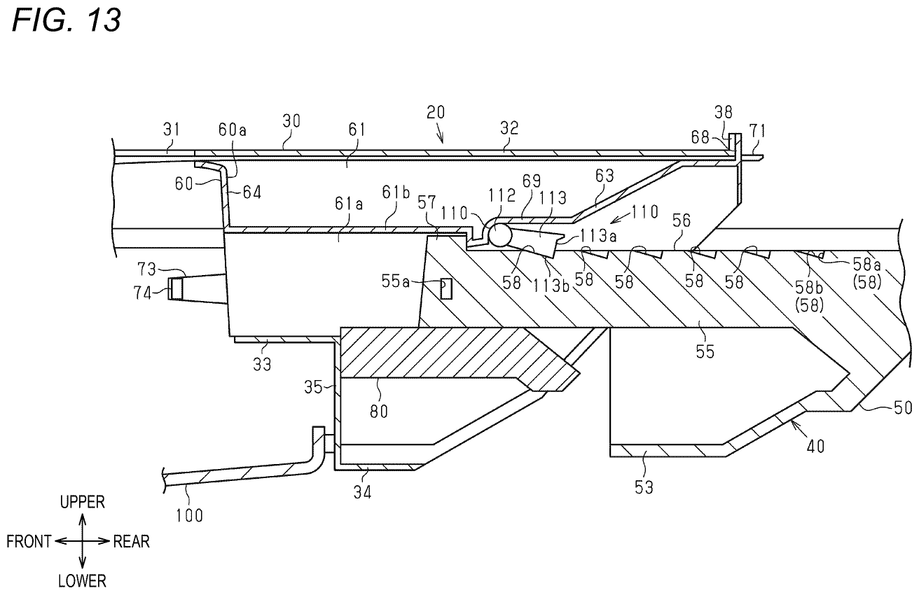

As shown in FIG. 12, when the outer member 50 further moves rearward, the pin 111 enters the regulating recess 58 that is located immediately in front of the regulating recess 58 located at the rearmost position. At this time, even when the outer member 50 attempts to move to a front side to approach the inner member 60, the first surface 113a comes into contact with the regulating surface 58a, so that the movement is restricted.

By repeating the above operation, the pin 111 sequentially enters and exits the plurality of regulating recesses 58 arranged in the front-rear direction as the outer member 50 moves. The pin 111 allows the outer member 50 to move rearward away from the inner member 60 regardless of whether the pin 111 enters the regulating recess 58. The pin 111 restricts the outer member 50 from approaching the inner member 60 in a state of entering the regulating recess 58.

As shown in FIG. 13, in a state in which the pin 111 enters the regulating recess 58 located at a frontmost position, the protruding portion 57 of the outer member 50 comes into contact with the regulating protrusion 69 from the front. Accordingly, the outer member 50 is restricted from moving rearward beyond the regulating protrusion 69. As a result, the outer member 50 is restricted from falling off the inner member 60. Therefore, by activating the air bag device 90, the outer member 50 is released from a state in which the outer member 50 is engaged with the inner member 60 so as not to be movable with respect to the inner member 60, and is engaged with the inner member 60 so as to be movable with respect to the inner member 60. A position at which the outer member 50 stops in response to contact with the knee of the occupant P varies depending on a physique of the occupant P. The pin 111 enters any of the regulating recesses 58 according to the position at which the outer member 50 stops. Therefore, even when the physique of the occupant P varies, the occupant P can be suitably protected by the outer member 50.

### <Operations of Present Embodiment>

As shown in FIG. 7, the inflator 92 is operated when the impact sensor of the air bag device 90 outputs the detection signal indicating that an impact of a predetermined magnitude or more acts on the vehicle 10. Accordingly, the air bag 91 is deployed and inflated rearward since the inflation gas is supplied to the air bag 91. At this time, the outer member 50 moves rearward away from the inner member 60 by receiving the pressure from the air bag 91 that is deployed and inflated. The knee of the occupant P is protected by the outer member 50 that is in the state of being away from the inner member 60.

Meanwhile, the air bag 91 is deployed and inflated upward through the space between the inner member 60 and the outer member 50 that is in the state of being away from the inner member 60. Accordingly, the upper body of the occupant P is protected by the air bag 91.

As shown in FIG. 6, even when the glove box 40 opens the opening 12a, the impact sensor outputs the detection signal, and the inflator 92 is operated. In this case, the inner member 60 slides to a front side with respect to the case 30 due to the reaction force from the air bag 91 that is deployed and inflated, thereby retracting into the case 30. The outer member 50 moves rearward away from the inner member 60 by receiving the pressure from the air bag 91 that is deployed and inflated. Therefore, even when the glove box 40 opens the opening 12a, the knee of the occupant P is protected by the outer member 50.

As described above, by activating the air bag device 90, the knee of the occupant P is protected by the outer member 50, and the upper body of the occupant P is protected by the air bag 91.

### <Effects of Present Embodiment>

(1) The air bag device 90 is disposed in the space formed between the outer member 50 and the inner member 60 of the glove box 40. The outer member 50 is configured to move rearward away from the inner member 60 and protect the knee of the occupant P by receiving the pressure from the air bag 91 that is deployed and inflated. The air bag 91 is deployed and inflated upward through the space between the inner member 60 and the outer member 50 that is in the state of being away from the inner member 60.

According to the above configuration, the air bag device 90 is disposed in the space formed between the outer member 50 and the inner member 60 which constitute the glove box 40 disposed in front of the knee of the occupant P. Therefore, design for an upper portion of the instrument panel 11 is less likely to be limited as compared with a case in which the air bag device 90 is disposed inside the upper portion of the instrument panel 11. Therefore, it is possible to ensure the protection performance for the occupant P and to improve the degree of freedom in the design of the instrument panel 11.

According to the above configuration, it is possible to reduce a dimension of the upper portion of the instrument panel 11 in the upper-lower direction, and to dispose a device that protrudes from and retracts into the instrument panel 11 inside the upper portion of the instrument panel 11.

As compared with a case in which the air bag device 90 is disposed inside a lower portion of the instrument panel 11 located below the glove box 40, A dimension of the lower portion of the instrument panel 11 in the upper-lower direction can be reduced. Accordingly, it possible to prevent a space under a foot of the occupant P in the interior of the vehicle 10 from becoming smaller.

(2) The front surface of the pressure receiving portion 52 of the outer member 50 is inclined with respect to the upper-lower direction to be positioned rearward toward the upper side.

According to the above configuration, the movement of the air bag 91 is guided along the front surface of the pressure receiving portion 52, and thus the air bag 91 is easily deployed and inflated upward. Accordingly, the air bag 91 is easily deployed and inflated to the front of the upper body of the occupant P. Therefore, the protection performance for the occupant P is easily ensured.

(3) The outer member 50 includes the regulating portion 53 that protrudes to a front side from the outer member 50 and restricts the air bag 91 from being deployed and inflated below the outer member 50.

According to the above configuration, the air bag 91 is restricted from being deployed and inflated below the outer member 50 by the regulating portion 53. Accordingly, the air bag 91 is easily deployed and inflated upward through the space between the outer member 50 and the inner member 60. Therefore, the protection performance for the occupant P is easily ensured.

(4) The outer member 50 includes the support end portion 54 that supports the facing portion 91a from the front by biting into the lower portion of the air bag 91.

According to the above configuration, the facing portion 91a of the air bag 91 is supported from the front by the support end portion 54, and thus the facing portion 91a is restricted from moving to a front side. Accordingly, the upper body of the occupant P can be suitably protected by the air bag 91.

(5) The ratchet mechanisms 110 allow the outer member 50 to move rearward away from the inner member 60 and restrict the outer member 50 from approaching the inner member 60 when the air bag device 90 is activated.

According to the above configuration, the outer member 50 that protects the knee of the occupant P in the state of being away from the inner member 60 is restricted from approaching the inner member 60 by the ratchet mechanism 110. Accordingly, when a load acts on the outer member 50 from the rear due to contact between the outer member 50 and the knee of the occupant P, the outer member 50 is restricted from moving to a front side. Therefore, the knee of the occupant P can be suitably protected.

(6) The outer member 50 is engaged with the inner member 60 so as not to be movable with respect to the inner member 60 when the air bag device 90 is not activated. The outer member 50 is configured to be disengaged from the inner member 60 and move rearward away from the inner member 60 by receiving the pressure from the air bag 91 that is deployed and inflated when the air bag device 90 is activated.

According to the above configuration, the outer member 50 is integrated with the inner member 60 by being engaged with the inner member 60 so as not to be movable with respect to the inner member 60 when the air bag device 90 is not activated. Accordingly, the outer member 50, together with the inner member 60, exhibits a function of closing the opening 12a of the instrument panel 11.

Meanwhile, the outer member 50 is disengaged from the inner member 60 and moves rearward away from the inner member 60 by receiving the pressure from the air bag 91 when the air bag device 90 is activated. Accordingly, the outer member 50 exhibits a function of protecting the knee of the occupant P.

(7) The support member 100 supports the inner member 60 from the front via the case 30.

According to the above configuration, it is possible to prevent deformation of the inner member 60 due to the reaction force from the air bag 91 that is deployed and inflated. Therefore, it is possible to stabilize a behavior when the air bag 91 is deployed and inflated.

(8) The glove box 40 includes the outer member 50 and the inner member 60. the outer member 50 constitutes the design surface in the interior of the vehicle 10. The inner member 60 has the accommodation portion 60a capable of accommodating an accommodated object.

According to the above configuration, when the air bag 91 is not activated, the outer member 50 and the inner member 60 function as the glove box 40 having the accommodation portion 60a. Meanwhile, when the air bag 91 is activated, the outer member 50 functions as a member that protects the knee of the occupant P. Accordingly, the occupant protection device 20 can be applied to the vehicle 10 including the glove box 40.

### <Modifications>

The present embodiment can be modified and implemented as follows. The present embodiment and the following modifications can be combined with each other and implemented without technical contradiction.
The glove box 40 does not have to slide with respect to the case 30. For example, the glove box 40 may open and close the opening 12a by rotating in the forward-reverse direction around a rotation axis extending in the left-right direction with respect to the case 30.
The occupant protection device 20 may not be applied to the vehicle 10 including the glove box 40. The occupant protection device 20 may be applied to the vehicle 10 including the outer member 50 that constantly closes the opening 12a of the instrument panel 11 when the air bag device 90 is not activated. In this case, the occupant protection device 20 may not include the case 30 and the inner member 60.

When the occupant protection device 20 does not include the case 30, the occupant protection device 20 includes the outer member 50, the inner member 60, and the air bag device 90. In this case, since the outer member 50 and the inner member 60 do not function as the glove box 40, it is preferable that the inner member 60 is constantly fixed to the instrument panel 11. In this case, it is preferable that the support member 100 connects the frame 14 and the inner member 60.

In a case in which the occupant protection device 20 does not include the case 30 and the inner member 60, the occupant protection device 20 includes the outer member 50 and the air bag device 90. It is preferable that the outer member 50 is engaged with the instrument panel 11 so as not to be movable with respect to the instrument panel 11 when the air bag device 90 is not activated. In addition, it is preferable that the outer member 50 is configured to be disengaged from the instrument panel 11 and move rearward away from the instrument panel 11 by receiving the pressure of the air bag 91 when the air bag device 90 is activated. That is, the outer member 50 protects the knee of the occupant P in the state of moving rearward away from the instrument panel 11. In this case, it is preferable that the pin 111 of the ratchet mechanism 110 is attached inside the instrument panel 11.
The occupant protection device 20 may not include the support member 100.
The outer member 50 may not translate with respect to the inner member 60 when moving away from the inner member 60 during activation of the air bag device 90. For example, the outer member 50 may be configured to move away from the inner member 60 by rotating about a rotation axis that is supported by the inner member 60. The outer member 50 may be configured to move downward or upward away from the inner member 60.
As a configuration of the ratchet mechanism 110, various configurations can be adopted as long as the configuration allows the outer member 50 to move away from the inner member 60 and restricts the outer member 50 from approaching the inner member 60. For example, the ratchet mechanism 110 may include a gear and a regulating portion. The gear has ratchet teeth, and the regulating portion restricts the rotation of the gear to only one direction by meshing with the ratchet teeth.
The occupant protection device 20 may not include the ratchet mechanism 110.
The outer member 50 may not include the support end portion 54. Even in this case, the air bag 91 that is deployed and inflated is supported by the upper portion of the instrument panel 11 and the windshield 13. Therefore, the air bag 91 is restricted from moving to a front side.
The outer member 50 may not include the regulating portion 53.
The front surface of the pressure receiving portion 52 may not be inclined with respect to the upper-lower direction. The front surface of the pressure receiving portion 52 may be a flat surface extending in the upper-lower direction, that is, a flat surface orthogonal to the front-rear direction.

### REFERENCE SIGNS LIST

P: occupant
S: operation switch
10: vehicle
11: instrument panel
12: rear wall
12a: opening
13: windshield
14: frame
20: occupant protection device
30: case
31: case side wall
32: case top wall
33: first case bottom wall
34: second case bottom wall
35: case front wall
35a: first through hole
36: front opening
37: rear opening
38: first raised portion
39: guide groove
40: glove box
50: outer member
51: lid portion
52: pressure receiving portion
53: regulating portion
54: support end portion
54a: first engagement hole
55: outer side wall
55a: second engagement hole
56: planar portion
57: protruding portion
58: regulating recess
58a: regulating surface
58b: relief surface
60: inner member
60a: accommodation portion
61: inner side wall
61a: general portion
61b: overhang portion
62: first inner bottom wall
63: second inner bottom wall
64: inner front wall
65: inner rear wall
65a: second through hole
66: sliding shaft
67: cover portion
68: second raised portion
69: regulating protrusion
70: first engagement portion
71: first claw portion
72: second engagement portion
73: base portion
74: second claw portion
80: guide member
81: sliding surface
90: air bag device
91: air bag
91a: facing portion
92: inflator
100: support member
110: ratchet mechanism
111: pin
112: shaft portion
113: arm portion
113a: first surface
113b: second surface

What is claimed is:

1. An occupant protection device for a passenger seat for protecting an occupant seated in a passenger seat of a vehicle, comprising,
when front and rear in a front-rear direction of the vehicle are referred to as front and rear, respectively:
an outer member which closes an opening provided, in front of a knee of the occupant, in an instrument panel of the vehicle; and
an air bag device including an air bag configured to be deployed and inflated by supply of a gas to protect an upper body of the occupant, wherein
the air bag device is disposed in front of the outer member,
the outer member is configured to move rearward away from the instrument panel and protect the knee of the occupant by receiving a pressure from the air bag that is deployed and inflated, and
the air bag is deployed and inflated upward through a space between the instrument panel and the outer member that is in a state of being away from the instrument panel.

2. The occupant protection device for a passenger seat according to claim 1, wherein
the outer member includes a pressure receiving portion configured to receive the pressure from the air bag that is deployed and inflated, and
a front surface of the pressure receiving portion is inclined with respect to an upper-lower direction to be positioned rearward toward an upper side.

3. The occupant protection device for a passenger seat according to claim 1, wherein
the outer member includes a regulating portion protruding toward a front side from the outer member and configured to restrict the air bag from being deployed and inflated below the outer member.

4. The occupant protection device for a passenger seat according to claim 1, wherein
the air bag includes a facing portion configured to be deployed and inflated rearward of the outer member that is in the state of being away from the instrument panel so that the facing portion faces a front side of the upper body of the occupant, and
the outer member includes a support end portion configured to support the facing portion from a front side by biting into a lower portion of the air bag.

5. The occupant protection device for a passenger seat according to claim 1, further comprising:
a ratchet mechanism configured to allow the outer member to move rearward away from the instrument panel and restrict the outer member from approaching the instrument panel when the air bag device is activated.

6. The occupant protection device for a passenger seat according to claim 1, further comprising:
an inner member disposed in front of the outer member, wherein
the air bag device is disposed in a space between the outer member and the inner member, and
the outer member is configured to be engaged with the inner member so as not to be movable with respect to the inner member when the air bag device is not activated, and to be disengaged from the inner member and move rearward away from the instrument panel by receiving the pressure from the air bag that is deployed and inflated when the air bag device is activated.

7. The occupant protection device for a passenger seat according to claim 2, further comprising:
an inner member disposed in front of the outer member, wherein
the air bag device is disposed in a space between the outer member and the inner member, and
the outer member is configured to be engaged with the inner member so as not to be movable with respect to the inner member when the air bag device is not activated, and to be disengaged from the inner member and move rearward away from the instrument panel by receiving the pressure from the air bag that is deployed and inflated when the air bag device is activated.

8. The occupant protection device for a passenger seat according to claim 3, further comprising:
an inner member disposed in front of the outer member, wherein
the air bag device is disposed in a space between the outer member and the inner member, and
the outer member is configured to be engaged with the inner member so as not to be movable with respect to the inner member when the air bag device is not activated, and to be disengaged from the inner member and move rearward away from the instrument panel by receiving the pressure from the air bag that is deployed and inflated when the air bag device is activated.

9. The occupant protection device for a passenger seat according to claim 4, further comprising:
an inner member disposed in front of the outer member, wherein
the air bag device is disposed in a space between the outer member and the inner member, and
the outer member is configured to be engaged with the inner member so as not to be movable with respect to the inner member when the air bag device is not activated, and to be disengaged from the inner member and move rearward away from the instrument panel by receiving the pressure from the air bag that is deployed and inflated when the air bag device is activated.

10. The occupant protection device for a passenger seat according to claim 5, further comprising:
an inner member disposed in front of the outer member, wherein
the air bag device is disposed in a space between the outer member and the inner member, and
the outer member is configured to be engaged with the inner member so as not to be movable with respect to the inner member when the air bag device is not activated, and to be disengaged from the inner member and move rearward away from the instrument panel by receiving the pressure from the air bag that is deployed and inflated when the air bag device is activated.

11. The occupant protection device for a passenger seat according to claim 6, further comprising:
a support member fixed to a frame of the vehicle to support the inner member from a front side.

12. The occupant protection device for a passenger seat according to claim 7, further comprising:
a support member fixed to a frame of the vehicle to support the inner member from a front side.

13. The occupant protection device for a passenger seat according to claim 8, further comprising:
a support member fixed to a frame of the vehicle to support the inner member from a front side.

14. The occupant protection device for a passenger seat according to claim 9, further comprising:
a support member fixed to a frame of the vehicle to support the inner member from a front side.

15. The occupant protection device for a passenger seat according to claim 10, further comprising:
a support member fixed to a frame of the vehicle to support the inner member from a front side.

16. The occupant protection device for a passenger seat according to claim 6, further comprising:
a glove box configured to open and close the opening, wherein
the glove box includes the outer member and the inner member, the outer member constitutes a design surface of an interior of the vehicle, the inner member has an accommodation portion capable of accommodating an accommodated object.

17. The occupant protection device for a passenger seat according to claim 7, further comprising:
a glove box configured to open and close the opening, wherein
the glove box includes the outer member and the inner member, the outer member constitutes a design surface of an interior of the vehicle, the inner member has an accommodation portion capable of accommodating an accommodated object.

18. The occupant protection device for a passenger seat according to claim 8, further comprising:
a glove box configured to open and close the opening, wherein
the glove box includes the outer member and the inner member, the outer member constitutes a design surface of an interior of the vehicle, the inner member has an accommodation portion capable of accommodating an accommodated object.

19. The occupant protection device for a passenger seat according to claim 9, further comprising:
a glove box configured to open and close the opening, wherein
the glove box includes the outer member and the inner member, the outer member constitutes a design surface of an interior of the vehicle, the inner member has an accommodation portion capable of accommodating an accommodated object.

20. The occupant protection device for a passenger seat according to claim 10, further comprising:
a glove box configured to open and close the opening, wherein
the glove box includes the outer member and the inner member, the outer member constitutes a design surface of an interior of the vehicle, the inner member has an accommodation portion capable of accommodating an accommodated object.
